(19) United States
(12) Patent Application Publication
(10) Pub. No.: US 2026/0059212 A1
(43) Pub. Date: Feb. 26, 2026

(54) SYSTEM SUPPORTING MODULARITY OF TRANSCEIVERS

(71) Applicant: ARRIS Enterprises LLC, SUWANEE, GA (US)

(72) Inventors: Erik J. GRONVALL, Bloomington, MN (US); John Charles CHAMBERLAIN, Hickory, NC (US); David BOWLER, Stow, MA (US)

(73) Assignee: ARRIS Enterprises LLC, Horsham, PA (US)

(21) Appl. No.: 19/103,471

(22) PCT Filed: Apr. 28, 2023
(86) PCT No.: PCT/US23/20485

§ 371 Date: Feb. 12, 2025

Related U.S. Application Data
(60) Provisional application No. 63/397,563, filed on Aug. 12, 2022.

(51) Int. Cl. H04Q 11/00; H04L 12/28

(52) U.S. Cl. CPC H04Q 11/0067; H04L 12/2801

(57) ABSTRACT

A networking system that includes modular transceivers.

### CROSS REFERENCE TO RELATED APPLICATIONS

The present application claims the benefit of U.S. Provisional Patent Application Ser. No. 63/397,563 filed Aug. 12, 2022.

### BACKGROUND

The subject matter of this application relates to modulatory of transceivers.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

Referring to FIG. 1, in a PON 10, a set of optical fibers and passive interconnecting devices are used for most or all of the communications through the extent of the access network. A set of one or more optical network terminals (ONTs) 11 are devices that are typically positioned at a subscriber's residence location (e.g., or business location). The term “ONT” includes what is also referred to as an optical network unit (ONU). There may be any number of ONTs associated with a single optical splitter 12. By way of example, 32 or 64 ONTs are often associated with the single network optical splitter 12. The optical splitter 12 is interconnected with the respective ONTs 11 by a respective optical fiber 13, or otherwise a respective fiber within an optical fiber cable. Selected ONTs may be removed and/or added to the access network associated with the optical splitter 12, as desired. There may be multiple optical splitters 12 that are arranged in a cascaded arrangement.

The optical fibers 13 interconnecting the optical splitter 12 and the ONTs 11 act as access (or “drop”) fibers. The optical splitter 12 is typically located in a street cabinet or other structure where one or more optical splitters 12 are located, each of which are serving their respective set of ONTs. In some cases, an ONT may service a plurality of subscribers, such as those within a multiple dwelling unit (e.g., apartment building). In this manner, the PON may be considered a point to multipoint topology in which a single optical fiber serves multiple endpoints by using passive fiber optic splitters to divide the fiber bandwidth among the endpoints.

An optical line terminal (OLT) 14 is located at the central office where it interfaces directly or indirectly with a core network 15. An interface 16 between the OLT 14 and the core network 15 may be one or more optical fibers, or any other type of communication medium. The OLT 14 forms optical signals for transmission downstream to the ONTs 11 through a feeder optical fiber 17, and receives optical signals from the ONTs 11 through the feeder optical fiber 17. The optical splitter 12 is typically a passive device that distributes the signal received from the OLT 14 to the ONTs 11. Similarly, the optical splitter 12 receives optical signals from the ONTs 11 and provides the optical signals though the feeder optical fiber 17 to the OLT 14. In this manner, the PON includes an OLT with a plurality of ONTs, which reduces the amount of fiber necessary as compared with a point-to-point architecture.

As it may be observed, an optical signal is provided to the feeder fiber 17 that includes all of the data for the ONTs 11. Accordingly, all the data being provided to each of the ONTs is provided to all the ONTs through the optical splitter 12. Each of the ONTs selects the portions of the received optical signals that are intended for that particular ONT and passes the data along to the subscriber, while discarding the remaining data. Typically, the data to the ONTs are broadcast to the feeder fiber 17 and provided to each of the ONTs.

Upstream transmissions from the ONTs 11 through the respective optical fibers 13 are typically transmitted in bursts according to a schedule provided to each ONT by the OLT. In this way, each of the ONTs 11 will transmit upstream optical data at different times. In some embodiments, the upstream and downstream transmissions are transmitted using different wavelengths of light so that they do not interfere with one another. In this manner, the PON may take advantage of wavelength-division multiplexing, using one wavelength for downstream traffic and another wavelength for upstream traffic on a single mode fiber.

The schedule from the OLT allocates upstream bandwidth to the ONTs. Since the optical distribution network is shared, the ONT upstream transmission would likely collide if they were transmitted at random times. The ONTs typically lie at varying distances from the OLT and/or the optical splitter, resulting in a different transmission delay from each ONT. The OLT measures the delay and sets a register in each ONT to equalize its delay with respect to the other ONTs associated with the OLT. Once the delays have been accounted for, the OLT transmits so-called grants in the form of grant maps to the individual ONTs. A grant map is a permission to use a defined interval of time for upstream transmission. The grant map is dynamically recalculated periodically, such as for each frame. The grant map allocates bandwidth to all the ONTs, such that each ONT receives timely bandwidth allocation for its service needs. Much of the data traffic, such as browsing websites, tends to have bursts and tends to be highly variable over time. By way of a dynamic bandwidth allocation (DBA) among the different ONTs, a PON can be oversubscribed for upstream traffic.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a network that includes a passive optical network.

FIG. 2 illustrates a network with a broadband network gateway.

FIG. 3 illustrates a plurality of different planes.

FIG. 4 illustrates an access network that includes a server and a switch with detachably engageable transceivers.

FIGS. 5A-5C illustrate a COTS server, switch, and transceivers.

FIG. 6 illustrates MAC layer processing.

FIG. 7 illustrates data prioritization.

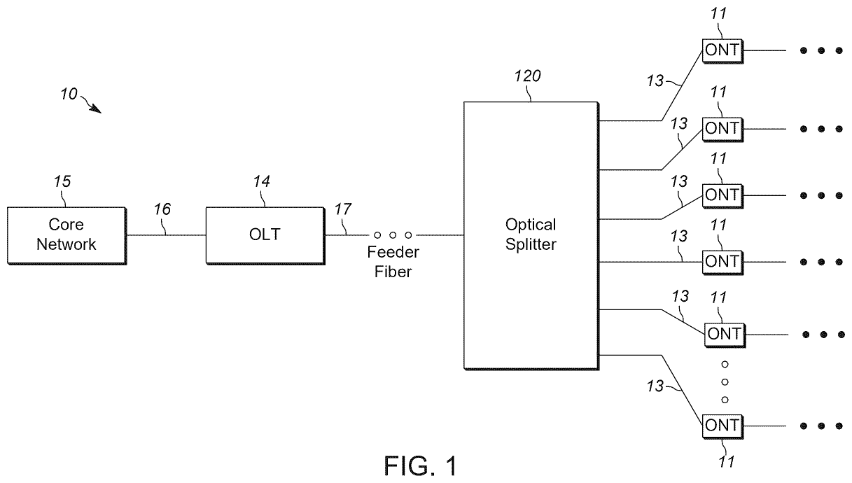

### DETAILED DESCRIPTION

Traditionally, the optical line terminals are maintained at the core network location which is typically a datacenter where they are interconnected to the core network with a suitable connection, such as a fiber optical cable or an Ethernet cable, and the ONTs and other components are located outside the core network datacenter and are likewise interconnected to the optical line terminal by a fiber optical cable. In some PON network configurations, the optical line terminals are located at locations remote to the core network, such as at various cabinets, vaults, or otherwise (generally referred to herein as a “node”) within the network itself. The fiber optic cables each include optical fibers that provide data connectivity between the core network and the respective optical network terminals.

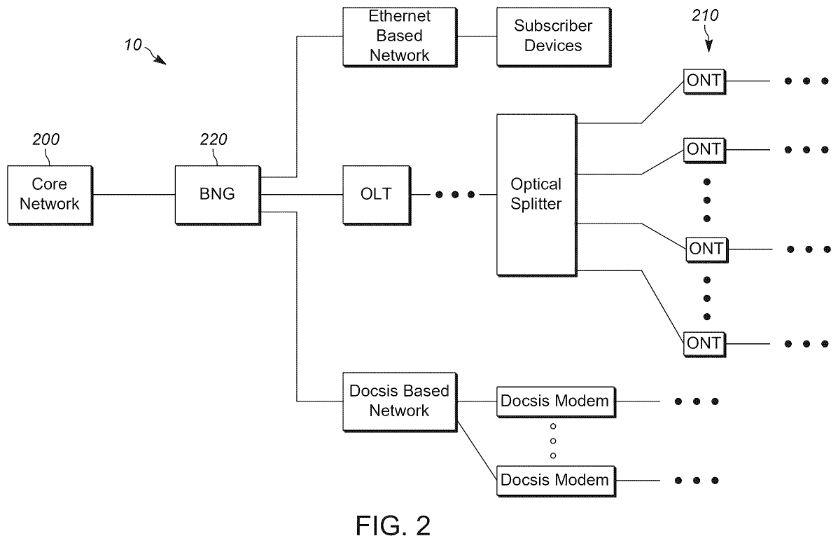

In some cases, a plurality of OLTs may be directly interconnected to the core network, which manages the data traffic to and from each of the OLTs. Referring to FIG. 2, a modified architecture provides a more robust interconnection between a core network 200 and ONTs 210, where a broadband network gateway (“BNG”) 220 provides an access point for the ONTs through which they connect to the broadband network. When a connection is established between the BNG 220 and the ONTs 210, the subscriber can access broadband services provided by a network service provider or an Internet service provider. For example, the BNG 220 may establish and manage subscriber sessions. When a session is active, the BNG 220 may aggregate traffic from various subscriber sessions for the ONTs and route it to the network service provider or the Internet service provider through the core network 200. The BNG 220 may provide subscriber management functions, such as for example, authentication, authorization, address assignment, security, policy management, and/or quality of service. The BNG 220 may also be interconnected to other types of services in addition to PON, such as those using DOCSIS based protocols through coaxial cables. The BNG 220 may also support providing Ethernet protocols. Accordingly, the BNG 220 may be configured to support multiple access layer technologies. The BNG 220 may also support timing requirements among the different access layer technologies, each of which are different. In this manner, each of the different ports of the BNG 220 may be configured provide services one of a plurality of different types of services.

The PON based network, the DOCSIS based network, and/or Ethernet based network each have different timing distributions for timing synchronization, where each of the underlying technologies distributes the timing synchronization among its associated devices in a different manner. Each of the different networking technologies are interconnected to a different port of the BNG 220. The BNG 220 accommodates the different timing distributions among the different ports and provides the timing synchronization in a different manner based upon the network technologies interconnected to each of the ports. The BNG 220 also aggregates the data traffic from each of the different ports, having different timing synchronization, and provides the resulting data to the core network in a unified manner on the same physical and logical connection with respect to the timing synchronization.

The computational power of microprocessor based commercial off the shelf (COTS) server platforms are increasing while the expense of such systems is decreasing over time. With such systems, a computing system may be, if desired, virtualized and operated using one or more COTS servers, generally referred to herein as a virtual machine. Using container technologies running on the COTS server and/or virtual machine, the COTS server may operate with only a single operating system. Each of the virtualized applications may then be isolated using software containers, such that the virtualized application may not see and are not aware of other virtualized applications operating on the same machine. Typically, each COTS server includes one or more Intel/AMD processors (or other processing devices) with associated memory and networking capabilities running an operating system software. Typically, the COTS servers include a framework and an operating system where user applications are run on such framework and the operating system is abstracted away from the actual operating system. Each virtual machine may be instantiated and operated as one or more software applications running on a COTS server. A plurality of software containers may be instantiated and operated on the same COTS server and/or the same virtual machine. A plurality of COTS servers are typically included in one or more data centers, each of which are in communication with one another. A plurality of COTS servers may be located in different geographic areas to provide geo-redundancy. In some embodiments, the container may include the same functionality as a virtual machine, or vice versa. In some embodiments, a grouping of containerized components, generally referred to as a pod, may be in the form of a virtual machine.

In some embodiments, the COTS servers may be “bare metal” servers that typically include an operating system thereon together with drivers and a portion of a container orchestration system. One or more containers are then added to the “bare metal” server while being managed by the container orchestration system. The container orchestration system described herein may likewise perform as, and be referred to as, a virtual machine orchestration system, as desired. In some embodiments, “bare metal” servers may be used with pods running on the operating system thereon together with drivers and a container orchestration system. In some embodiments, virtual machines may be omitted from the COTS servers.

Selected software processes that are included on a line card and/or a remote PHY device may be run on a “bare metal” server and/or virtual machine, including software containers, running on a COTS server, including both “active” and “back-up” software processes. The functionality provided by such a “bare metal” server and/or virtual machine may include higher level functions such as for example, packet processing that includes routing Internet packet provisioning, layer 2 virtual private networking which operates over pseudowires, and multiprotocol label switching routing. The functionality provided by such a “bare metal” server and/or virtual machine may include DOCSIS functions such as for example, DOCSIS MAC and encapsulation, channel provisioning, service flow management, quality of service and rate limiting, scheduling, and encryption. The functionality provided by such a “bare metal” server and/or virtual machine may include video processing such as for example, EQAM and MPEG processing.

Each of the COTS servers and/or the virtual machines and/or software containers may contain different hardware profiles and/or frameworks. For example, each of the COTS servers and/or “bare metal” servers and/or virtual machines and/or software containers may execute on different processor types, different number of processing cores per processor, different amounts of memory for each processor type, different amounts of memory per processing core, different cryptographic capabilities, different amounts of available off-processor memory, different memory bandwidth (DDR) speeds, and varying types and capabilities of network interfaces, such as Ethernet cards. In this manner, different COTS servers and/or “bare metal” servers and/or virtual machines and/or software containers may have different processing capabilities that vary depending on the particular hardware. Each of the COTS servers and/or “bare metal” servers and/or the virtual machine and/or software containers may contain different software profiles. For example, each of the COTS servers and/or “bare metal” servers and/or virtual machines and/or software containers may include different software operating systems and/or other services running thereon, generally referred to herein as frameworks. In this manner, different COTS servers and/or “bare metal” servers and/or virtual machines and/or software containers may have different software processing capabilities that vary depending on the particular software profile.

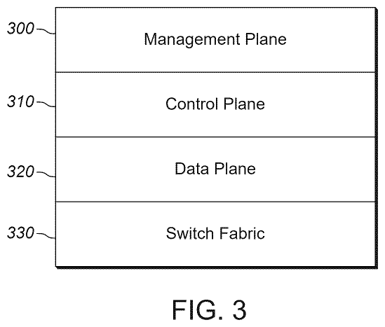

Referring to FIG. 3, for data processing and for transferring data across a network, the architecture of the hardware and/or software may be configured in the form of a plurality of different planes, each of which performing a different set of functionality. In relevant part the layered architecture may include different planes such as a management plane 300, a control plane 310, a data plane 320, and switch fabric 330 to effectuate sending and receiving packets of data.

For example, the management plane 300 may be generally considered as the user interaction or otherwise the general software application being run. The management plane typically configures, monitors, and provides management and configuration served to all layers of the network stack and other portions of the system.

For example, the control plane 310 is a component to a switching function that often includes system configuration, management, and exchange of routing table information and forwarding information. Typically, the exchange of routing table information is performed relatively infrequently. A route controller of the control plane 310 exchanges topology information with other switches and constructs a routing table based upon a routing protocol. The control plane may also create a forwarding table for a forwarding engine. In general, the control plane may be thought of as the layer that makes decisions about where traffic is sent. Since the control functions are not performed on each arriving individual packet, they tend not to have a strict speed constraint.

For example, the data plane 320 parses packet headers for switching, manages quality of service, filtering, medium access control, encapsulations, and/or queuing. As a general matter, the data plane carriers the data traffic, which may be substantial in the case of cable distribution networks. In general, the data plane may be thought of as the layer that primarily forwards traffic to the next hop along the path to the selected destination according to the control plane logic through the switch fabric. The data plane tends to have strict speed constraints since it is performing functions on each arriving individual packet.

For example, the switch fabric 330 provides a network topology to interconnect network nodes via one or more network switches.

As the system increasingly scales to support additional customers, additional COTS servers and/or “bare metal” servers and/or virtual machines and/or software containers are included with the system to expand the processing capability of the overall system. To provide processing redundancy, one or more additional COTS servers and/or “bare metal” servers and/or virtual machines and/or software containers may be included that are assigned as “back-up” which are exchanged for an “active” process upon detection of a failure event. The scaling of the data plane 320 on COTS servers and/or “bare metal” servers and/or virtual machines and/or software containers to service dynamically variable processing requirements should be performed in such a manner that ensures sufficiently fast processing of data packets and sufficient bandwidth for the transmission of the data packets to ensure they are not otherwise lost. The COTS servers do not include architectures that are especially suitable for supporting PON networks, but are rather designed for as a generic data handling access platform.

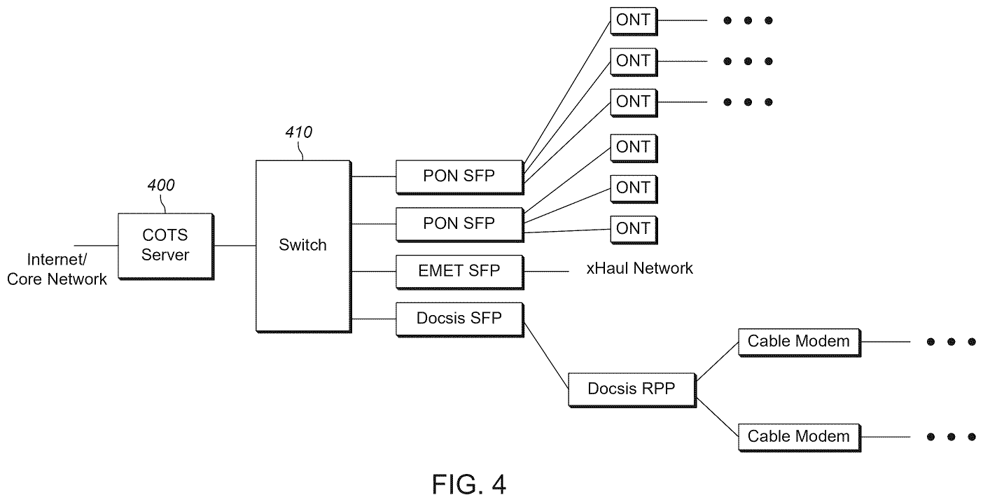

Referring to FIG. 4, a COTS server 400 in combination with a switch 410 may be configured in a manner so that it is more suitable for providing data communications for a PON network. The COTS server 400 in combination with the switch 410 may include one or more slots that are suitable for supporting one or more detachably engageable cards within one or more ports. Each of the cards includes a transceiver with a physical interface that provides data communications suitable for the optical PON network. In another embodiment, the COTS server 400 in combination with the switch 410 may include one or more small form-factor pluggable (“SFP”) ports, that are suitable for supporting one or more detachably engageable small form-factor pluggable transceivers (“SFP module”). Each of the SFP modules includes a transceiver with a physical interface that provides data communications suitable for the optical PON network. The COTS server 400 in combination with the switch 410 may include multiple different types of detachably engageable interfaces and associated transceivers. In some embodiments, the functionality of the switch 410 may be integrated with the COTS server 400. For example, the PON network may include protocols suitable for ATM passive optical network, broadband PON, Ethernet PON, XG-PON, XGS-PON, NG-PON2, TWDM-PON, Gigabit Ethernet PON (EPON, GE-PON, GPON), etc. Further, the COTS server 400 in combination with the switch 410 may support other protocols and data services, such as DOCSIS based remote physical devices (e.g., cable modems). Further, the COTS server 400 in combination with the switch 410 may support other protocols, such as Ethernet based communications for cellular network-based communications or otherwise a network device.

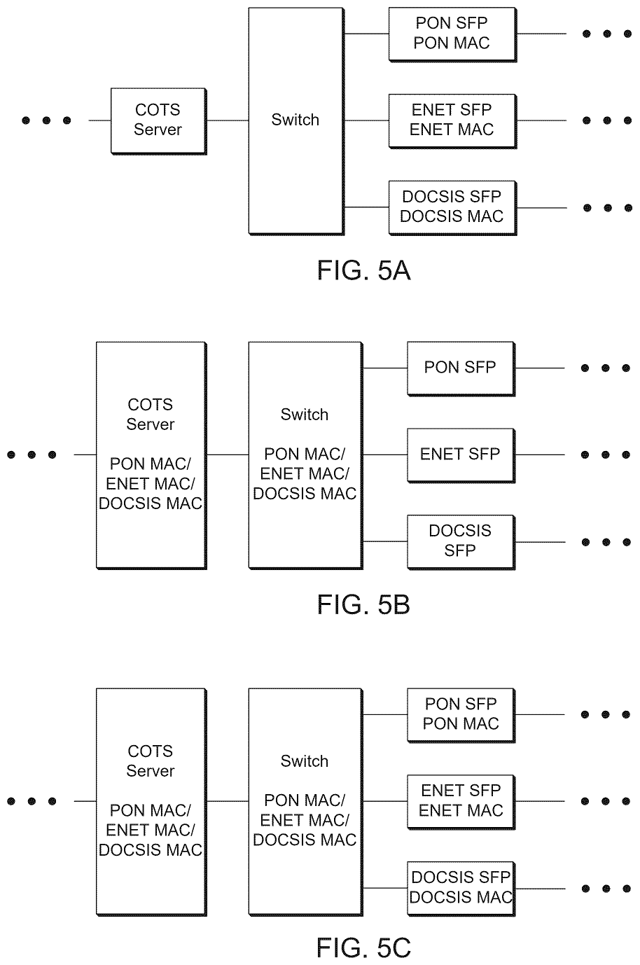

Referring to FIG. 5A, the MAC layer for supporting the PON network, or other type of network, may be included within the respective detachably engageable transceiver. In this manner, the COTS server and/or switch provides data to the respective transceiver and the MAC layer of the respective transceiver controls the physical layer processing suitable for the PON network or other respective communication protocol. In this manner, the MAC layer processing for the particular service is performed by the respective transceiver.

Referring to FIG. 5B, the MAC layer for supporting the PON network, or other type of network, may be included within the COTS server and/or switch which is interconnected to the detachably engageable transceiver which acts to receive and forward the data on a respective signal path (e.g., Ethernet cable, optical fiber, co-axial cable). In this manner, the COTS server and/or switch does the MAC layer processing suitable for the PON network or other respective network and provides data to the respective transceiver which acts to forward and receive the data on a respective signal path (e.g., Ethernet cable, optical fiber, co-axial cable). In this manner, the MAC layer processing is performed for the particular service by the respective COTS server and/or switch. Any MAC layer included in the transceiver is minimal to simply control the transmission and receiving of the data.

Referring to FIG. 5C, the MAC layer for supporting the PON network, or other type of network, may be included partially within the COTS server and/or switch which is interconnected to the detachably engageable transceiver which acts to receive and forward the data on a respective signal path (e.g., Ethernet cable, optical fiber, co-axial cable) that also includes a portion of the MAC layer for supporting the PON network, or other type of network. In this manner, the COTS server and/or switch in combination with the detachably engageable transceiver does the MAC layer processing suitable for the PON network or other respective network which acts to receive and forward the data on a respective signal path (e.g., Ethernet cable, optical fiber, co-axial cable). In this manner, the MAC layer processing for the particular service is performed by the respective COTS server and/or switch in combination with the detachably engageable transceiver.

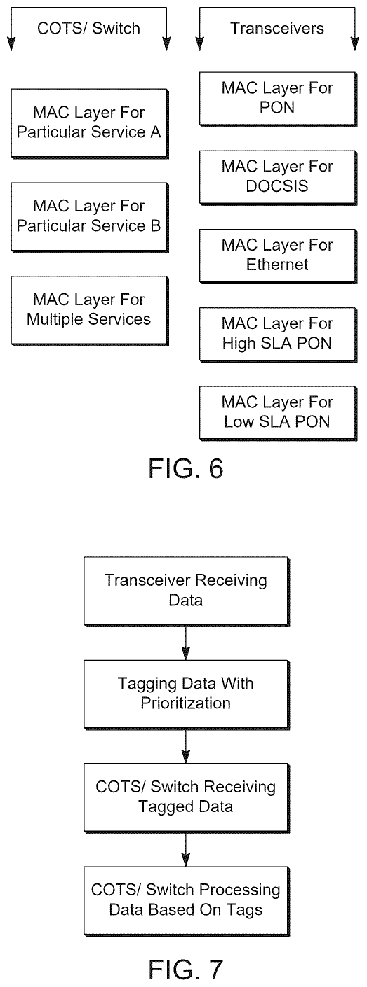

Referring to FIG. 6, it is often desirable to include selected MAC layer processing for the PON network on the COTS server and/or switch and other selected MAC layer processing for the PON network on the transceiver. Often data and other services are provided by multiple-system operators which has a system that includes multiple cables, direct-broad satellite, PON based optical line terminals, cable modem termination systems, converged cable access platforms, Ethernet services, telecommunications, among other systems. Also, the multiple-system operators normally include a complicated routing system supporting leaf-spine networks. Furthermore, each of the types of systems supported by the multiple-system operators often includes various generations of services, each of which may be somewhat different than the other generations. By way of example, a multiple-system operator may include high service level agreement customers that are provided service using a dedicated Ethernet link, may include low service level agreement legacy consumers using GPON, may include business service legal agreement customers having a higher level of service than legacy consumers, and relatively high service level agreement commercial customers using a PON system. Accordingly, it would be burdensome to partition and configure the core network to independently support each of these different types of customers. Further, depending on the capabilities and the complexities of the particular access technology, the MAC layer processing may vary in complexity. In particular, the MAC layer processing performed by the COTS server and/or switch, and other selected MAC layer processing for the PON network at the transceiver varies based upon the complexities of the particular access technology.

A transceiver associated with each port and/or slot may be designed for the particular types of services to be provided by the respective transceiver. Further, the transceiver may be designed for a particular class of service for the particular types of services to be provided by the respective transceiver. Also, the transceiver may be designed for multiple types of services to be provided by the respective transceiver, which is a mixture of various services.

To more effectively provide MAC layer processing for multiple different types of services, it is desirable to include MAC layer processing on the transceiver that is tailored for the particular service provided by the respective transceiver. Accordingly, a set of transceivers may be used, each of which is suitable for one or more particular services. The COTS server and/or switch may likewise include MAC layer processing for the particular services provided by the corresponding transceivers. Further, the COTS server and/or switch may include MAC layer processing for multiple services.

The MAC layer services provided by the COTS server and/or switch preferably include one or more services that are related to the management of different subscribers that are associated with multiple transceivers. In this manner, the MAC layer processing may be performed in a manner that manages multiple different types of services in a joint manner, and also reduces the computational complexity associated with the respective transceivers.

For example, the MAC layer services provided by the COTS server and/or switch may include a mapping that indicates a port and/or a slot where received data for a particular subscriber is forwarded to.

For example, the MAC layer services provided by the COTS server and/or switch may include a mapping for received data for a particular subscriber that identifies which service is associated with the corresponding subscriber, and if desired, modifying the data in a manner that takes into account of the differences in scheduling of data transmission between the different types of services (e.g., DOCSIS, Ethernet, PON).

For example, the MAC layer services provided by the COTS server and/or switch may include a prioritization of one of the port(s) and/or slot(s) to forward data to with respect to other port(s) and/or slot(s). In this manner, if data is delayed in being forwarded to the appropriate port and/or slot, it is performed in a prioritized manner. In this manner, if data is dropped and thus need to be retransmitted, it is performed in a prioritized manner. In this manner, the prioritization of services for different subscribers may be performed across different ports and/or slots, and also across different types of services (e.g., cable modem termination system supporting DOCSIS through hybrid-fiber coaxial cables, passive optical networks through optical fibers, and Ethernet across Ethernet based connections). Typically, the interconnection from the COTS server and/or switch to the core network is based upon an Ethernet based connection.

For example, the MAC layer services provided by the COTS server and/or switch may be prioritized based upon the data rates and/or a service level agreement of a particular subscriber.

For example, the MAC layer services provided by the COTS server and/or switch may be cooperative managed to set up and manage particular virtual LAN on a port by port basis. In this manner, a set of devices that share the same physical network may be associated with the same broadcast domain. This permits the virtual LAN to support different functional and security requirements.

The interconnection between the COTS server and/or the switch and the core network is preferably designed in a manner that accommodates dissimilar technologies from which the data is coming from (e.g., cable modem termination system supporting DOCSIS through hybrid-fiber coaxial cables, passive optical networks through optical fibers, Ethernet across Ethernet based connections) or multiple sources of the same type of technologies with different technologies providing the service (e.g., G. PON, E. PON and/or NG-PON2, or DOCSIS 3.0, DOCSIS 3.1, and/or DOCSIS 4.0). The interconnection to the core is preferably sized to have data capacity to be less than the total maximum data capacity of the subscribers. For example, if there are 10 PON ports, each of which has a 1G capacity, the interconnection to the core is preferably substantially less than 10G to facilitate a particular level of oversubscription. Accordingly, the MAC layer processing on the COTS server and/or the switch preferably includes traffic management that manages the dissimilar technologies from which the data is coming from and/or the multiple varied sources with similar technologies. In this manner, the COTS server and/or switch may make a determination as to which data is prioritized in some manner to the core network, which other data is delayed in its transmission to the core network, and which other data is potentially dropped as a result of excessive backpressure between the COTS server and/or switch and the core network.

Referring to FIG. 7, one technique to provide prioritization across various services may include the respective transceivers, each for a particular type of service, to modify the packaging of the data that is being provided upstream to the COTS server and/or switch. The modification of the packaging may include tagging the data in a manner that includes a prioritization that the COTS server and/or switch can use to prioritize the manner in which the data is provided to the core network. In the case that there is no backpressure on the interconnection between the COTS server and/or switch, then the priority tagging may be ignored, if desired. In the case that there is backpressure on the interconnection between the COTS server and/or switch, then the priority tagging may be used to determine which data has priority over other data, across the disparate types of services. The tags providing prioritization may be included at the level of the particular PON service, such as a set of levels of 1-10 prioritization, for a PON service. The tags providing prioritization may be included at the level of the particular Ethernet service, such as a set of levels of 1-10 prioritization, for an Ethernet service. The tags providing prioritization may be included at the level of the particular DOCSIS based service, such as a set of levels of 1-10 prioritization, for a DOCSIS based service.

However, the levels of the prioritization for the different types of services may be selected such that a prioritization level of 5 (or other) for PON is the same as a prioritization level of 5 (or other) for DOCSIS based service which is the same as a prioritization level of 5 (or other) for an Ethernet service, and so forth. Also, the prioritization within a service may be modified based upon a service level agreement and/or a quality of service. Also, a mapping may be used to determine a relative prioritization between the different types of service and/or classes of service (e.g., a prioritization of 4 for Ethernet may have a higher priority than a prioritization of 6 for PON). Based upon the tagging, the COTS server and/or switch may queue the packets into various queues, each of which are processed in some manner for providing data to the core, such as the highest priority data is selected over the lower priority data. Otherwise, the data may be queued to a suitable queue, and prioritized in some manner. By tagging the data, the COTS server and/or switch is alleviated from the need to otherwise inspect each packet to determine a prioritization, which is computationally complex.

For example, while all data from the customers may be treated in the same manner, the different types of data may be treated with different prioritization. For example, a voice call may have a higher priority that data messages, which in turn may have a higher priority than ack messages.

It is noted that the link between the COTS server and/or switch and the core is a shared physical link and shared logical link among the various subscribers, so that all the data is processed by the COTS server and/or switch done in the same manner.

Preferably, the tagging of the data is performed by the transcoder, which has MAC layer processing that is aware of the nature of the data that is being transmitted to the COTS and/or switch.

Also, the data transmission between the COTS server and/or switch and the transceiver may be allocated among the various services based upon a prioritization tag for the data, so that a relative prioritization may be achieved among the different services.

The separation of the services between the transceiver and the COTS server and/or switch preferably includes the burst clock recovery being included with the transceiver. The burst clock recovery signals the start of a burst of data to the optical receiver so that it may reacquire the signal because the power level and/or phase may be different than the previous burst. This reduces timing concerns that are more likely to occur if the burst clock recovery was included with the COTS server and/or switch instead.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A distribution system comprising:
(a) a broadband network gateway that establishes and manages subscriber sessions that receives data from a core network that is provided to a plurality of optical network terminals of a passive optical network;
(b) said broadband network gateway that receives and aggregate data from said plurality of optical network terminals that is provided to said core network;
(c) said broadband network gateway establishes and manages subscriber sessions that receives data from said core network that is provided to at least one of a DOCSIS based network and an Ethernet based network;
(d) said broadband network gateway supports passive optical network timing synchronization of said passive optical network, and said respective at least one of DOCSIS timing requirements and Ethernet timing synchronization.

2. The distribution system of claim 1 wherein said broadband network gateway further includes authentication, authorization, and address assignment for said distribution system.

3. A distribution system comprising:
(a) a server and a switch that includes a plurality of detachably engageable transceivers;
(b) each of said plurality of detachably engageable transceivers including a MAC layer that provides control for interaction with a transmission medium;
(c) a plurality of said detachably engageable transceivers receiving data from said server and switch, and in response to said receiving, providing data to a respective set of optical network terminals through a respective said transmission medium that comprises a respective optical fiber.

4. The distribution system of claim 3 further comprising a plurality of said detachably engageable transceivers receiving data from said server and switch, and in response to said receiving, providing data to a respective set of cable modems through a respective said transmission medium that comprises a coaxial cable.

5. The distribution system of claim 3 further comprising a plurality of said detachably engageable transceivers receiving data from said server and switch, and in response to said receiving, providing data to a respective set of network devices through a respective said transmission medium that comprises an Ethernet cable.

6. The distribution system of claim 3 further comprising at least one of said server and switch including another MAC layer that provides processing suitable for each of respective said MAC layer of each of said plurality of detachably engageable transceivers.

7. A distribution system comprising:
(a) a server and a switch that includes a plurality of detachably engageable transceivers;
(b) a first said plurality of detachably engageable transceivers including a first MAC layer that provides control for interaction with a first transmission medium;
(c) said first plurality of said detachably engageable transceivers receiving data from said server and switch, and in response to said receiving, providing data to a respective set of optical network terminals through a respective said transmission medium that comprises a respective optical fiber;
(d) a second said plurality of detachably engageable transceivers including a second MAC layer that provides control for interaction with a second transmission medium;
(e) said second plurality of said detachably engageable transceivers receiving data from said server and switch, and in response to said receiving, providing data to a respective set of cable modems through a respective said transmission medium that comprises a respective coaxial cable;
(f) at least one of said server and switch including another MAC layer that provides processing suitable for each of respective said first MAC layer and said second MAC layer of each of respective said first and second plurality of detachably engageable transceivers.

8. The distribution system of claim 7 wherein said another MAC layer includes a prioritization of said first and second plurality of detachably engageable transceivers.

9. The distribution system of claim 8 wherein said prioritization is based upon service level agreements.

10. The distribution system of claim 8 wherein said prioritization is based upon data rates.

11. A distribution system comprising:
(a) a server and a switch that includes a plurality of detachably engageable transceivers;
(b) a first said plurality of detachably engageable transceivers including a first MAC layer that provides control for interaction with a first transmission medium;
(c) said first plurality of said detachably engageable transceivers receiving data from a respective set of optical network terminals through a respective said transmission medium that comprises a respective optical fiber, and in response to said receiving, providing first data to said server and switch;
(d) a second said plurality of detachably engageable transceivers including a second MAC layer that provides control for interaction with a second transmission medium;
(e) said second plurality of said detachably engageable transceivers receiving data from a respective set of cable modems through a respective said transmission medium that comprises a coaxial cable, and in response to said receiving, providing second data to said server and switch;
(f) at least one of said server and switch including providing first data and said second data to a core network based upon a prioritization.

12. The distribution system of claim 11 wherein said prioritization is based upon tags of said first data and said second data.

13. The distribution system of claim 12 wherein said first plurality of detachably engageable transceivers supplements received first data with said tags.

14. The distribution system of claim 13 wherein said second plurality of detachably engageable transceivers supplements received second data with said tags.
